(19) United States
(12) Patent Application Publication
(10) Pub. No.: US 2026/0244807 A1
(43) Pub. Date: Aug. 20, 2026

(54) METHOD FOR REINFORCING AND LIFTING BUILDING BASED ON NUMERICAL SIMULATION

(71) Applicant: Beijing Hengxiang Hongye Foundation Reinforcement Technology Co., Ltd, Beijing (CN)

(72) Inventor: Tengyue CUI, Beijing (CN)

(73) Assignee: Beijing Hengxiang Hongye Foundation Reinforcement Technology Co., Ltd, Beijing (CN)

(21) Appl. No.: 19/646,652

(22) Filed: Apr. 14, 2026

Related U.S. Application Data
(63) Continuation of application No. PCT/CN2025/070736, filed on Jan. 6, 2025.

(30) Foreign Application Priority Data
Dec. 5, 2023 (CN) 2023116498707

(51) Int. Cl. G06F 30/13; G06F 30/20; G06F 111/10

(52) U.S. Cl. CPC G06F 30/13; G06F 30/20; G06F 2111/10

(57) ABSTRACT

A method for reinforcing and lifting a building based on numerical simulation includes: establishing an initial building model representing a building undergoing settlement, and acquiring an initial settlement displacement of the building; adjusting parameters of a shallow foundation under a building raft foundation based on the initial building model to simulate reinforcement of the shallow foundation and form a post-reinforcement shallow foundation model; adjusting parameters of a deep foundation under the building raft foundation based on the post-reinforcement shallow foundation model to simulate reinforcement of the deep foundation and form a post-reinforcement deep foundation model; and dividing an intermediate lifting layer located between the deep foundation and the shallow foundation into a plurality of lifting zones based on the post-reinforcement deep foundation model, and performing corresponding simulated lifting according to a settlement displacement of each region to achieve simulated lifting of the building.

### CROSS-REFERENCE TO RELATED APPLICATIONS

The application claims priority to Chinese patent application No. 2023116498707, filed on Dec. 5, 2023, the entire contents of which are incorporated herein by reference.

### TECHNICAL FIELD

The present disclosure relates to the technical field of building foundation reinforcement and rectification, and in particular to a method for reinforcing and lifting a building based on numerical simulation.

### BACKGROUND

Currently, the proliferation of high-rise buildings has resulted in increasingly severe problems such as various uneven settlements of structures. Grouting rectification technology has prominent advantages in terms of rectification effects, working space, and environmental factors, and compaction grouting technology can effectively cause ground lifting, and has advantages such as economy, high efficiency, and environmental protection, making it widely used in building incline rectification projects. However, due to the strong concealment of the grouting technology, current engineering practices for building rectification mainly rely on relevant experience, which usually easily leads to increased costs, environmental impacts, and safety problems. Existing methods are mostly based on theory and laboratory tests to study a lifting effect of compaction grouting, and therefore, there is a lack of an economical, efficient, and instructive numerical simulation method.

### SUMMARY

An objective of the present disclosure is to solve at least one technical problem in the background, and to provide a method for reinforcing and lifting a building based on numerical simulation.

To achieve the above objective, the present disclosure provides a method for reinforcing and lifting a building based on numerical simulation, including:
based on a Midas-gts numerical modeling system, establishing an initial building model representing a building undergoing settlement, and acquiring an initial settlement displacement of the building according to the initial building model;
adjusting parameters of a shallow foundation under a building raft foundation based on the initial building model to simulate reinforcement of the shallow foundation and form a post-reinforcement shallow foundation model;
adjusting parameters of a deep foundation under the building raft foundation based on the post-reinforcement shallow foundation model to simulate reinforcement of the deep foundation and form a post-reinforcement deep foundation model; and
dividing an intermediate lifting layer located between the deep foundation and the shallow foundation into a plurality of lifting zones based on the post-reinforcement deep foundation model, and performing corresponding simulated lifting according to a settlement displacement of each zone to achieve simulated lifting of the building.

According to an aspect of the present disclosure, the establishing an initial building model representing a building undergoing settlement includes:
based on a Midas-gts numerical modeling system, establishing a soil geometric model and a building geometric model according to geological survey data parameters and building construction drawing data parameters;
inputting material property parameters into the soil geometric model and the building geometric model, respectively;
meshing the soil geometric model and the building geometric model; and
loading gravity loads and static soil boundary conditions onto the meshed soil geometric model and building geometric model to form the initial building model; where
the material property parameters include an elastic modulus, a void ratio, a Poisson's ratio, and a unit weight.

According to an aspect of the present disclosure, a boundary of the soil geometric model is larger than a boundary of the building geometric model.

According to an aspect of the present disclosure, the geological survey data includes a soil profile and a foundation design parameter table, and the soil geometric model is constructed using the soil profile and the foundation design parameter table.

According to an aspect of the present disclosure, the adjusting parameters of a shallow foundation under a building raft foundation based on the initial building model to simulate reinforcement of the shallow foundation and form a post-reinforcement shallow foundation model includes:
based on the Midas-gts numerical modeling system, on the basis of the initial building model, increasing an elastic modulus of a soil layer of the shallow foundation and reducing a void ratio to achieve reinforcement of the shallow foundation and form the post-reinforcement shallow foundation model.

According to an aspect of the present disclosure, a settlement displacement of the building raft foundation obtained through the post-reinforcement shallow foundation model approaches or equals a settlement displacement of the building raft foundation in the initial building model.

According to an aspect of the present disclosure, the adjusting parameters of a deep foundation under the building raft foundation based on the post-reinforcement shallow foundation model to simulate reinforcement of the deep foundation and form a post-reinforcement deep foundation model includes:
based on the Midas-gts numerical modeling system, on the basis of the post-reinforcement shallow foundation model, increasing an elastic modulus of a soil layer of the deep foundation and reducing a void ratio to achieve reinforcement of the deep foundation and form the post-reinforcement deep foundation model.

According to an aspect of the present disclosure, the dividing an intermediate lifting layer located between the deep foundation and the shallow foundation into a plurality of lifting zones, and performing corresponding simulated lifting according to a settlement displacement of each zone to achieve simulated lifting of the building includes:
dividing the intermediate lifting layer into a plurality of lifting zones;
setting different volume expansion coefficients according to settlement conditions of each lifting zone; and
performing simulated lifting on each lifting zone according to each volume expansion coefficient to achieve simulated grouting lifting of the building.

According to an aspect of the present disclosure, the method further includes: arranging a plurality of simulated lifting monitoring points around the building geometric model in the initial building model, and when simulated lifting of the building is performed, and monitoring a simulated lifting displacement value at each point of the building by each simulated lifting monitoring point.

According to an aspect of the present disclosure, boundaries of the shallow foundation, the intermediate lifting layer, and the deep foundation are in a range extending 3 to 5 m outward from a boundary of the building raft foundation.

According to the solution of the present disclosure, different volume expansion coefficients are set for different settlement zones of the soil in the intermediate lifting layer. The grouting pressure effect is simulated using the volume expansion coefficients, such that the soil in the intermediate lifting layer expands in volume and squeezes an overlying soil layer, thereby achieving the purpose of lifting the overlying building. In this way, the lifting change of the building becomes more intuitive and clearer, and consistency between a simulated building lifting effect and an actual engineering building lifting effect is achieved.

According to the solution of the present disclosure, simulation data of the lifting displacement (i.e., simulated lifting displacement values) are obtained through various monitoring points. The simulated lifting displacement data are compared with on-site engineering monitoring data, and the feasibility of an actual compaction grouting reinforcement and building lifting construction solution is verified.

In an actual grouting process, different grouting design solutions result in significantly different lifting effects. In many cases, problems such as increased project costs due to grout waste and difficulty in controlling the grouting effect easily occur, thereby posing safety hazards to the grouting project. The present disclosure employs a numerical simulation method to perform an optimization design on an actual grouting rectification project, thereby achieving both engineering economy and safety.

### BRIEF DESCRIPTION OF DRAWINGS

FIG. 1 schematically shows a flow chart of a method for reinforcing and lifting a building based on numerical simulation according to an embodiment of the present disclosure.

FIG. 2 is a diagram of an initial building model in Embodiment 1.

FIG. 3 is a north-south settlement diagram of an initial building model in Embodiment 1.

FIG. 4 is an east-west settlement diagram of an initial building model in Embodiment 1.

FIG. 5 is a top view of a building reinforcement and lifting zone in Embodiment 1.

FIG. 6 is a schematic diagram of shallow reinforcement of a soil layer profile in Embodiment 1.

FIG. 7 is a schematic diagram of deep reinforcement of a soil layer profile in Embodiment 1.

FIG. 8 is a schematic diagram of lifting of an intermediate lifting layer of a soil layer profile in Embodiment 1.

FIG. 9 is a schematic diagram of zoned expansion lifting of an intermediate lifting layer in Embodiment 1.

FIG. 10 is a north-south building model diagram after lifting in Embodiment 1.

FIG. 11 is an east-west building model diagram after lifting in Embodiment 1.

FIG. 12 is a schematic diagram of displacement monitoring points in Embodiment 1.

FIG. 13 is a graph of west-side lifting displacement simulation and monitoring data in Embodiment 1.

FIG. 14 is a graph of east-side lifting displacement simulation and monitoring data in Embodiment 1.

### DETAILED DESCRIPTION OF THE EMBODIMENTS

The content of the present disclosure will now be discussed with reference to exemplary embodiments. It should be understood that the discussed embodiments are only for the purpose of enabling those of ordinary skill in the art to better understand and thereby implement the content of the present disclosure, and are not intended to imply any limitation on the scope of the present disclosure.

As used herein, the term “includes” and its variants are to be interpreted as open-ended terms meaning “includes, but is not limited to”. The term “based on” is to be interpreted as “based at least in part on”. The term “one embodiment” and “an embodiment” are to be interpreted as “at least one embodiment”.

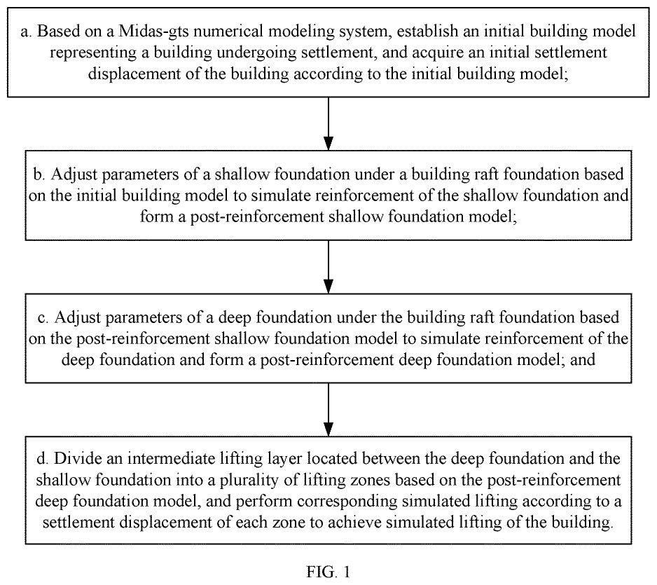

FIG. 1 schematically shows a flow chart of a method for reinforcing and lifting a building based on numerical simulation according to an embodiment of the present disclosure. As shown in FIG. 1, a method for reinforcing and lifting a building based on numerical simulation includes:
a. based on a Midas-gts numerical modeling system, an initial building model representing a building undergoing settlement is established, and an initial settlement displacement of the building is acquired according to the initial building model;
b. parameters of a shallow foundation under a building raft foundation are adjusted based on the initial building model to simulate reinforcement of the shallow foundation and form a post-reinforcement shallow foundation model;
c. parameters of a deep foundation under the building raft foundation are adjusted based on the post-reinforcement shallow foundation model to simulate reinforcement of the deep foundation and form a post-reinforcement deep foundation model; and
d. an intermediate lifting layer located between the deep foundation and the shallow foundation is divided into a plurality of lifting zones based on the post-reinforcement deep foundation model, and corresponding simulated lifting is performed according to a settlement displacement of each zone to achieve simulated lifting of the building.

Further, according to an embodiment of the present disclosure, in the above step a, the establishing an initial building model representing a building undergoing settlement includes:
based on a Midas-gts numerical modeling system, a soil geometric model and a building geometric model are established according to geological survey data parameters and building construction drawing data parameters;
material property parameters are input into the soil geometric model and the building geometric model, respectively;
the soil geometric model and the building geometric model are meshed; and
gravity loads and static soil boundary conditions are loaded onto the meshed soil geometric model and building geometric model to form the initial building model; where
the material property parameters include a plurality of parameters such as an elastic modulus, a void ratio, a Poisson's ratio, and a unit weight.

In this embodiment, the soil geometric model and the building geometric model are established according to data such as geological survey data and building construction drawings, the material property parameters are input, and the loads and boundary conditions are added to form the above initial building model. After the initial building model is calculated, the initial building model includes a stress diagram, a strain diagram, a settlement deformation diagram, a bending moment diagram, a shear force diagram, and the like, and the initial settlement displacement of the building in the above step a may be acquired from the settlement deformation diagram. The content related to the settlement displacement described below can also be acquired from the corresponding settlement deformation diagram in each model, and the related content will not be repeated.

In this embodiment, a boundary of the soil geometric model is larger than a boundary of the building geometric model. With this configuration, an influence of the boundary conditions of the soil geometric model on a simulated lifting (e.g., simulating grouting lifting by expansion coefficients as described below) process is reduced.

In this embodiment, the geological survey data includes a soil profile and a foundation design parameter table, and the soil geometric model is constructed using the soil profile and the foundation design parameter table. That is, actual soil layer profile parameters are used when the soil geometric model is established. With this configuration, the stratum settlement condition can be reflected more realistically, and the uneven settlement displacement of the building can be simulated more accurately.

Further, according to an embodiment of the present disclosure, in the above step b, the adjusting parameters of a shallow foundation under a building raft foundation based on the initial building model to simulate reinforcement of the shallow foundation and form a post-reinforcement shallow foundation model includes:
based on the Midas-gts numerical modeling system, on the basis of the initial building model, an elastic modulus of a soil layer of the shallow foundation is increased and a void ratio is reduced to achieve reinforcement of the shallow foundation and form the post-reinforcement shallow foundation model. With this configuration, reinforcement of the shallow foundation can improve the strength and stiffness of the zone, coordinate the stress on a foundation slab, ensure the uniformity of the lifting effect, avoid hidden hazards such as secondary tilting or foundation cracking of the building caused by an excessively large local lifting amount, and better ensure the lifting effect.

In this embodiment, a settlement displacement of the building raft foundation obtained through the post-reinforcement shallow foundation model approaches or equals a settlement displacement of the building raft foundation in the initial building model. That is, the building raft foundation in the post-reinforcement shallow foundation model undergoes little or no settlement compared with the building raft foundation in the initial building model. With this configuration, it may be ensured that the shallow foundation is sufficiently reinforced, the compactness meets requirements, the secondary settlement of the soil is controlled within a small range, or the soil does not undergo secondary settlement.

Further, according to an embodiment of the present disclosure, in the above step c, the adjusting parameters of a deep foundation under the building raft foundation based on the post-reinforcement shallow foundation model to simulate reinforcement of the deep foundation and form a post-reinforcement deep foundation model includes:
based on the Midas-gts numerical modeling system, on the basis of the post-reinforcement shallow foundation model, an elastic modulus of a soil layer of the deep foundation is increased and a void ratio is reduced to achieve reinforcement of the deep foundation and form the post-reinforcement deep foundation model. With this configuration, reinforcement of the deep foundation may form a bearing layer with a certain range and thickness and a sufficient bearing capacity, thereby providing a good supporting point for lifting of the intermediate lifting layer.

Further, according to an embodiment of the present disclosure, in the above step d, the dividing an intermediate lifting layer located between the deep foundation and the shallow foundation into a plurality of lifting zones, and performing corresponding simulated lifting according to a settlement displacement of each region to achieve simulated lifting of the building includes:
the intermediate lifting layer is divided into a plurality of lifting zones;
different volume expansion coefficients are set according to settlement conditions of each lifting zone; and
simulated lifting is performed on each lifting zone according to each volume expansion coefficient to achieve simulated lifting of the building. With this configuration, the grouting pressure effect may simulated using the volume expansion coefficients to induce volume expansion and squeeze an overlying soil layer, thereby achieving the purpose of lifting the overlying building. Moreover, consistency between a simulated building lifting effect and an actual engineering effect of lifting the building by zoned grouting is ensured, and by continuously adjusting the volume expansion coefficients, the building is eventually lifted and the rectification effect is achieved.

Further, in this embodiment, the present disclosure further includes: a plurality of simulated lifting monitoring points are arranged around the building geometric model in the initial building model, and when simulated lifting of the building is performed, each simulated lifting monitoring point is configured to monitor a simulated lifting displacement value at each point of the building. With this configuration, the data and trends of the lifting displacement at each monitoring point may be monitored more clearly, and the feasibility of an actual compaction grouting rectification and building lifting construction solution by may be better verified.

Further, in this embodiment, boundaries of the shallow foundation, the intermediate lifting layer, and the deep foundation are in a range extending 3 to 5 m outward from a boundary of the building raft foundation. With this configuration, an action area of a base pressure is larger, and a range of a stress diffusion angle is increased, which can better resist an upper load and reduce uneven settlement of the foundation.

According to the above solution of the present disclosure, different volume expansion coefficients are set for different settlement zones of the soil in the intermediate lifting layer. The grouting pressure effect is simulated using the volume expansion coefficients, such that the soil in the intermediate lifting layer expands in volume and squeezes an overlying soil layer, thereby achieving the purpose of lifting the overlying building. In this way, the lifting change of the building becomes more intuitive and clearer, and consistency between a simulated building lifting effect and an actual engineering building lifting effect is achieved.

According to the above solution of the present disclosure, simulation data of the lifting displacement (i.e., simulated lifting displacement values) are obtained through various monitoring points. The simulated lifting displacement data are compared with on-site engineering monitoring data, and the feasibility of the actual compaction grouting reinforcement and building lifting construction solution is verified.

In an actual grouting process, different grouting design solutions result in significantly different lifting effects. In many cases, problems such as increased project costs due to grout waste and difficulty in controlling the grouting effect easily occur, thereby posing safety hazards to the grouting project. The present disclosure employs a numerical simulation method to perform a simulation and optimization design on an actual grouting rectification project, thereby achieving both engineering economy and safety.

Based on the above solution of the present disclosure, the solution of the present disclosure is described below in detail in a specific embodiment in combination with the drawings.

### Embodiment 1

For a certain residential building project, the building has one underground floor with a floor height of −5.7 m, and 26 above-ground floors, with a first floor height of 5.050 m and the remaining floor heights of 2.950 m. A raft foundation rests on a pebble layer. A bearing layer is a pebble layer with a high porosity, and there is plastic to soft plastic silty clay of varying thickness near or below the bearing layer. Uneven settlement occurs due to insufficient foundation bearing capacity. The foundation design parameters in the geological survey are shown in Table 1 below:

TABLE 1

| | | Characteristic | | | | |
|---|---|---|---|---|---|---|
| | Natural unit | value of subgrade | | | Deformation | |
| Stratum No. | weight | bearing capacity | Es1-2 | Es2-3 | modulus E0 | Poisson's |
| and name | γ (kN/m³) | fak (kPa) | (MPa) | (MPa) | (MPa) | Ratio |
| Miscellaneous | 17.5* | (under- | / | / | / | 0.15 |
| fill \textcircled{1}-1 | | consolidated and | | | | |
| | | uneven, not | | | | |
| | | provided) | | | | |
| Miscellaneous | 18.5* | (under- | / | / | / | 0.15 |
| fill \textcircled{1}-2 | | consolidated and | | | | |
| | | uneven, not | | | | |
| | | provided) | | | | |
| Pebble \textcircled{2} | 20.0* | 300 | / | / | 22.1 | 0.29 |
| Silty clay \textcircled{3}-1 | 19.5 | 200 | 7.5 | 9.8 | / | 0.25 |
| Silty clay \textcircled{3}-2 | 18.0 | 105 | 5.0 | 7.0 | / | 0.25 |
| Silty clay \textcircled{3}-3 | 16.5 | 75 | 3.8 | 5.0 | / | 0.25 |
| Completely | 20.5 | 310 | 11.0 | 15.0 | / | 0.28 |
| weathered | | | | | | |
| argillaceous | | | | | | |
| siltstone \textcircled{4}-1 | | | | | | |
| Strongly | 21.5* | 450 | | | 30* | 0.25 |
| weathered | | | | | | |
| argillaceous | | | | | | |
| siltstone \textcircled{4}-2 | | | | | | |
| Strongly | 21.5* | 600 | | | 40* | 0.2 |
| weathered | | | | | | |
| dolomite \textcircled{5}-1 | | | | | | |
| Moderately | 23.0* | 3000 | | | / | 0.2 |
| weathered | | | | | | |
| dolomite \textcircled{5}-2 | | | | | | |

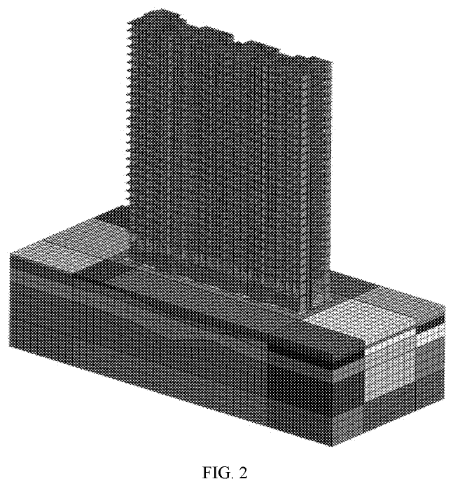

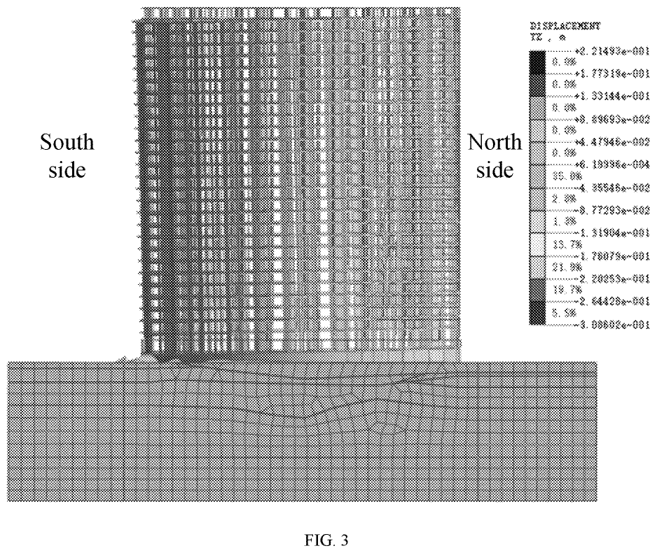

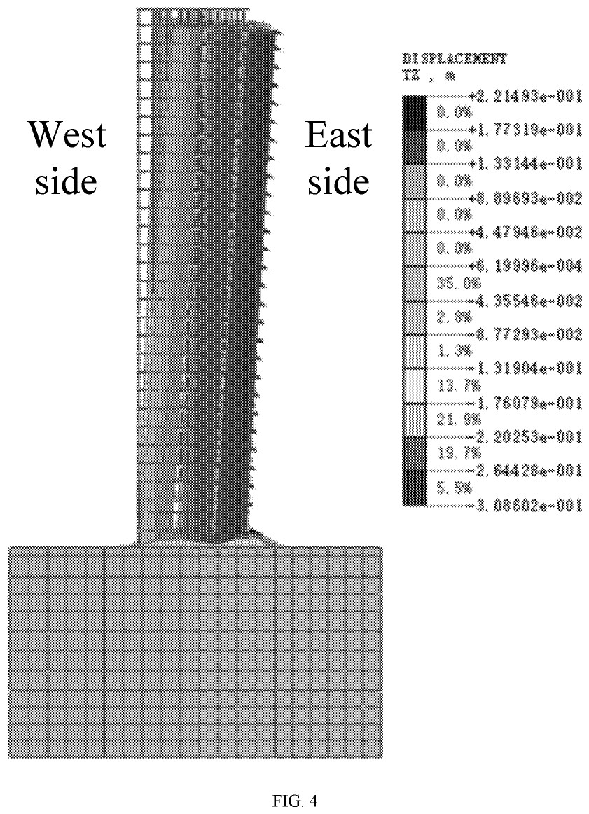

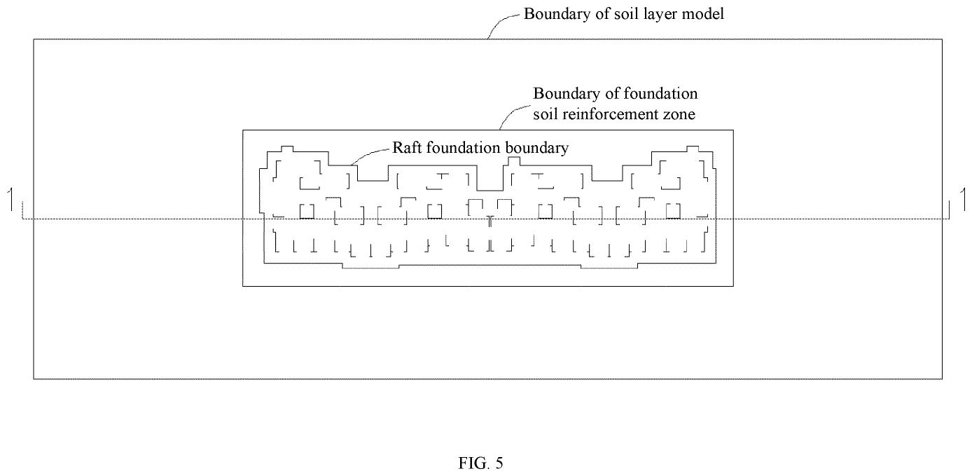

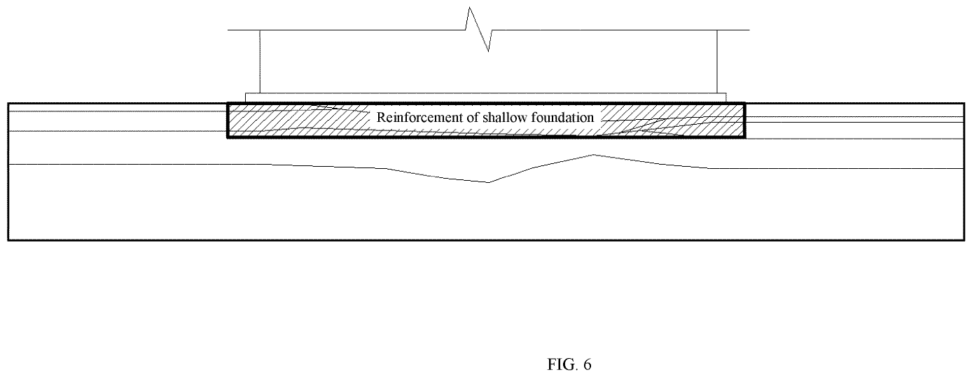

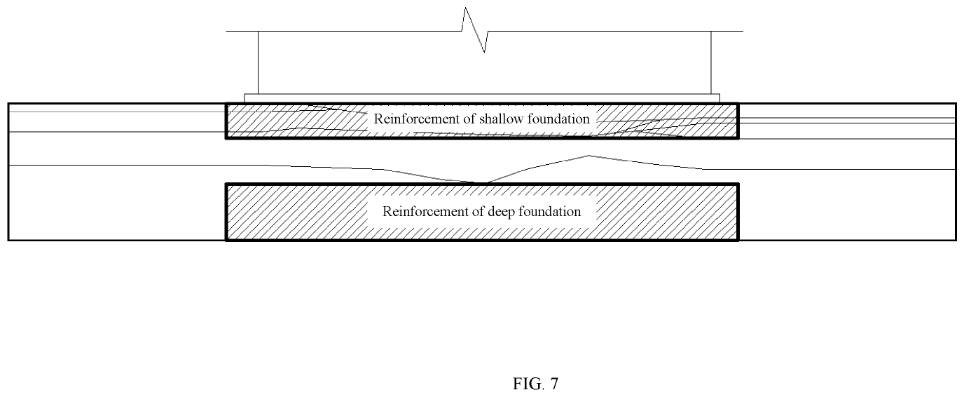

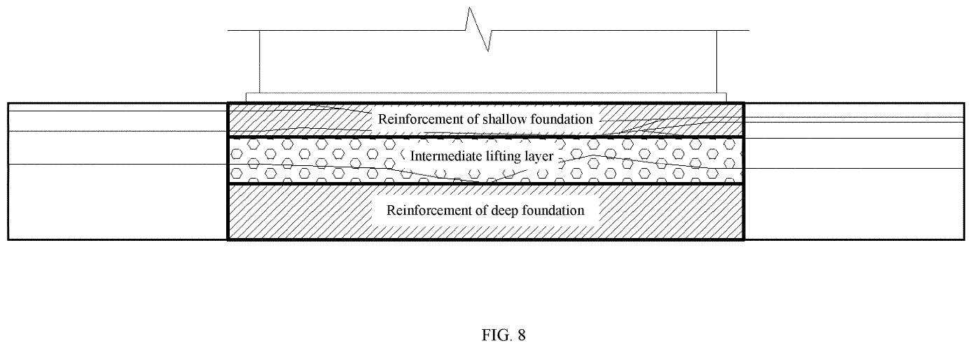

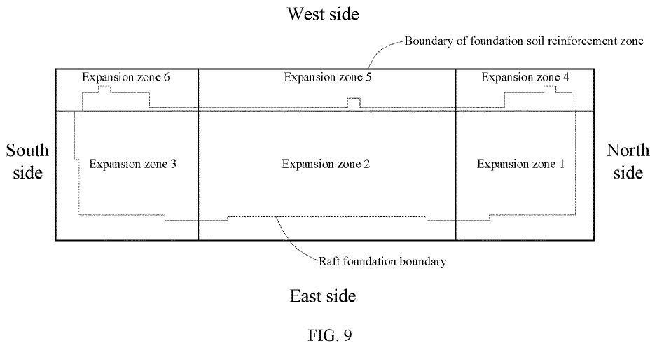

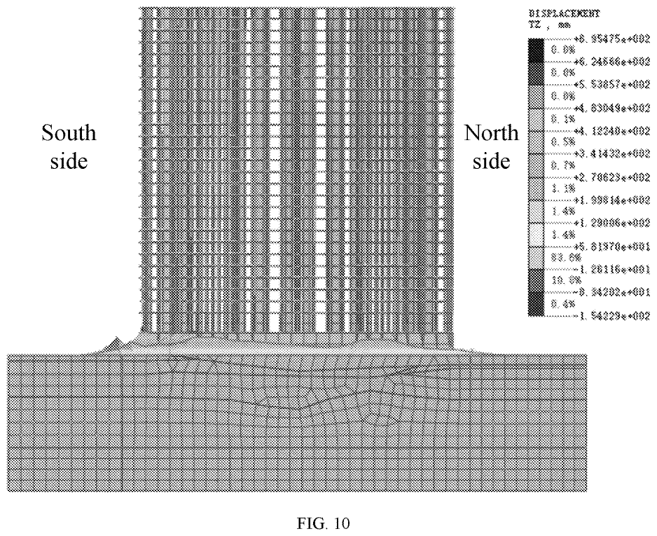

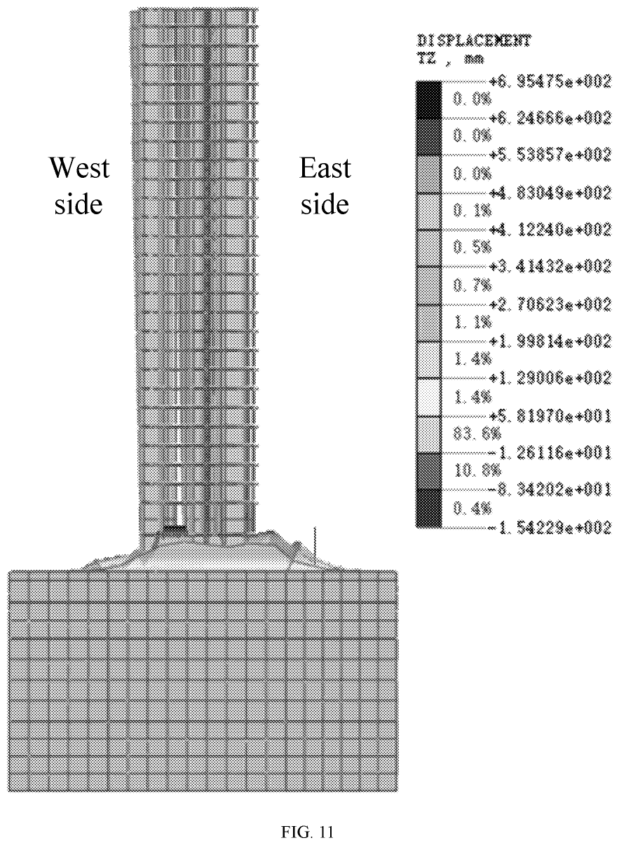

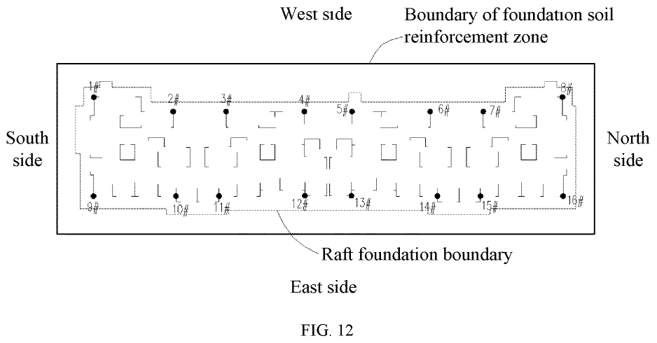

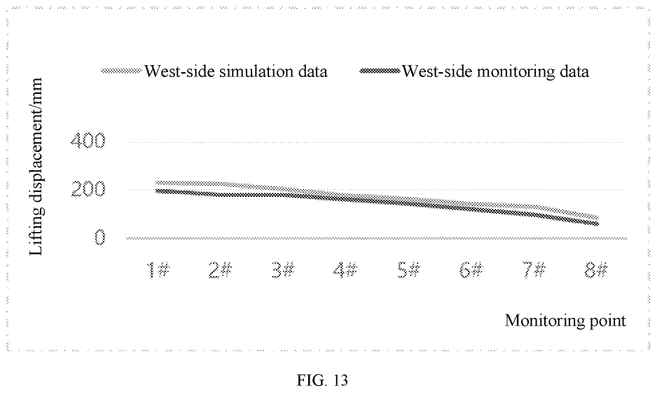

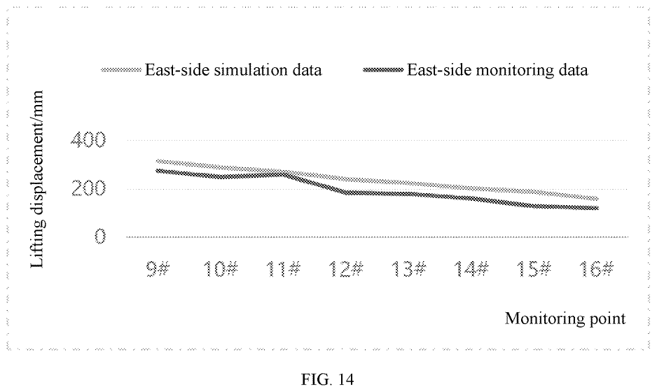

A Midas-gts modeling analysis was performed on a typical building with a raft foundation to verify the feasibility of the actual compaction grouting rectification and building lifting construction solution, thereby providing a reference example for similar projects:
Step 1, an initial building model was formed. According to data such as geological survey data and building construction drawings, a soil geometric model and a building geometric model were established, and materials and property parameters were input. An elastic modulus was taken as twice Es1-2, and parameters such as a Poisson's ratio and a unit weight were selected according to the data in the table. Gravity loads and static soil boundary conditions were added to form an initial building model, and an initial settlement displacement was calculated. The building tilts toward the southeast, as shown in FIG. 2, FIG. 3, and FIG. 4.
Step 2, a post-reinforcement shallow foundation model was formed. As shown in FIG. 5 and FIG. 6, based on the initial building model, an elastic modulus of a soil layer of a shallow foundation was increased and a void ratio is reduced to achieve reinforcement of the shallow foundation and form a post-reinforcement shallow foundation model, and a settlement displacement was calculated. Reinforcement of the shallow foundation can improve the strength and stiffness of the zone, coordinate the stress on a foundation slab, ensure the uniformity of the lifting effect, avoid hidden hazards such as secondary tilting or foundation cracking of the building caused by an excessively large local lifting amount, and better ensure the lifting effect.
Step 3, a post-reinforcement deep foundation model was formed. As shown in FIG. 5 and FIG. 7, based on the post-reinforcement shallow foundation model, an elastic modulus of a soil layer of the deep foundation was increased and a void ratio was reduced to achieve reinforcement of the deep foundation and form a post-reinforcement deep foundation model. Reinforcement of the deep foundation may form a bearing layer with a certain range and thickness and a sufficient bearing capacity, thereby providing a good supporting point for lifting of the intermediate lifting layer.
Step 4, an intermediate lifting layer was lifted. As shown in FIG. 5, FIG. 8, and FIG. 9, based on the deep foundation reinforced model, an intermediate soil layer was divided into six zones. According to the settlement condition of each zone, different “volume expansion coefficients &” were set: 81=12%, &2-12%, ¿3=14%, &4-2.5%, 85=2%, and 86=1.7%, and the grouting pressure effect was simulated to induce volume expansion and squeeze an overlying soil layer, thereby achieving the purpose of lifting the overlying building. The lifted building model is shown in FIG. 10 and FIG. 11. After the building lifting was completed, the simulated lifting displacement values of 16 monitoring points No. 1 # to No. 16 # on the east sides and west sides of the building were compared with on-site engineering monitoring data for analysis, and the feasibility of an actual compaction grouting rectification and building lifting construction solution was verified, as shown in FIG. 12, FIG. 13, and FIG. 14.

Finally, it should be noted that the above preferred embodiment is only used to illustrate the technical solution of the present disclosure, rather than limiting the technical solution. Although the present disclosure has been described in detail through the above preferred embodiment, those skilled in the art should understand that various changes in form and detail may be made without departing from the scope defined by the claims of the present disclosure.

What is claimed is:

1. A method for reinforcing and lifting a building based on numerical simulation, comprising:
based on a Midas-gts numerical modeling system, establishing an initial building model representing a building undergoing settlement, and acquiring an initial settlement displacement of the building according to the initial building model;
adjusting parameters of a shallow foundation under a building raft foundation based on the initial building model to simulate reinforcement of the shallow foundation and form a post-reinforcement shallow foundation model;
adjusting parameters of a deep foundation under the building raft foundation based on the post-reinforcement shallow foundation model to simulate reinforcement of the deep foundation and form a post-reinforcement deep foundation model; and
dividing an intermediate lifting layer located between the deep foundation and the shallow foundation into a plurality of lifting zones based on the post-reinforcement deep foundation model, and performing corresponding simulated lifting according to a settlement displacement of each zone to achieve simulated lifting of the building.

2. The method for reinforcing and lifting a building based on numerical simulation according to claim 1, wherein the establishing an initial building model representing a building undergoing settlement comprises:
based on a Midas-gts numerical modeling system, establishing a soil geometric model and a building geometric model according to geological survey data parameters and building construction drawing data parameters;
inputting material property parameters into the soil geometric model and the building geometric model, respectively;
meshing the soil geometric model and the building geometric model; and
loading gravity loads and static soil boundary conditions onto the meshed soil geometric model and building geometric model to form the initial building model; wherein
the material property parameters comprise an elastic modulus, a void ratio, a Poisson's ratio, and a unit weight.

3. The method for reinforcing and lifting a building based on numerical simulation according to claim 2, wherein a boundary of the soil geometric model is larger than a boundary of the building geometric model.

4. The method for reinforcing and lifting a building based on numerical simulation according to claim 2, wherein the geological survey data comprises a soil profile and a foundation design parameter table, and the soil geometric model is constructed using the soil profile and the foundation design parameter table.

5. The method for reinforcing and lifting a building based on numerical simulation according to claim 1, wherein the adjusting parameters of a shallow foundation under a building raft foundation based on the initial building model to simulate reinforcement of the shallow foundation and form a post-reinforcement shallow foundation model comprises:
based on the Midas-gts numerical modeling system, on the basis of the initial building model, increasing an elastic modulus of a soil layer of the shallow foundation and reducing a void ratio to achieve reinforcement of the shallow foundation and form the post-reinforcement shallow foundation model.

6. The method for reinforcing and lifting a building based on numerical simulation according to claim 1, wherein a settlement displacement of the building raft foundation obtained through the post-reinforcement shallow foundation model approaches or equals a settlement displacement of the building raft foundation in the initial building model.

7. The method for reinforcing and lifting a building based on numerical simulation according to claim 1, wherein the adjusting parameters of a deep foundation under the building raft foundation based on the post-reinforcement shallow foundation model to simulate reinforcement of the deep foundation and form a post-reinforcement deep foundation model comprises:
based on the Midas-gts numerical modeling system, on the basis of the post-reinforcement shallow foundation model, increasing an elastic modulus of a soil layer of the deep foundation and reducing a void ratio to achieve reinforcement of the deep foundation and form the post-reinforcement deep foundation model.

8. The method for reinforcing and lifting a building based on numerical simulation according to claim 1, wherein the dividing an intermediate lifting layer located between the deep foundation and the shallow foundation into a plurality of lifting zones, and performing corresponding simulated lifting according to a settlement displacement of each region to achieve simulated lifting of the building comprises:
dividing the intermediate lifting layer into a plurality of lifting zones;
setting different volume expansion coefficients according to settlement conditions of each lifting zone; and
performing simulated lifting on each lifting zone according to each volume expansion coefficient to achieve simulated grouting lifting of the building.

9. The method for reinforcing and lifting a building based on numerical simulation according to claim 1, wherein the method further comprises: arranging a plurality of simulated lifting monitoring points around the building geometric model in the initial building model, and when simulated lifting of the building is performed, monitoring a simulated lifting displacement value at each point of the building by each simulated lifting monitoring point.

10. The method for reinforcing and lifting a building based on numerical simulation according to claim 1, wherein boundaries of the shallow foundation, the intermediate lifting layer, and the deep foundation are in a range extending 3 to 5 m outward from a boundary of the building raft foundation.
